(19) United States
(12) Patent Application Publication
(10) Pub. No.: US 2015/0379585 A1
(43) Pub. Date: Dec. 31, 2015

(54) Single Sheet Planning

(71) Applicants: Joerg Hendricks, Baie d' Urfe (CA); Michel Martin, Pierrefonds (CA); Edward Palmer, Montreal (CA); Rischa Poncik, Dorval (CA); Roman Sauber, Montreal (CA); Jean-Luc Terree, Sevres (FR); Isabelle Thore, Notre-Dame-de-Grace (CA); Jonathan Viau, St-Hubert (CA)

(72) Inventors: Joerg Hendricks, Baie d' Urfe (CA); Michel Martin, Pierrefonds (CA); Edward Palmer, Montreal (CA); Rischa Poncik, Dorval (CA); Roman Sauber, Montreal (CA); Jean-Luc Terree, Sevres (FR); Isabelle Thore, Notre-Dame-de-Grace (CA); Jonathan Viau, St-Hubert (CA)

(73) Assignee: SAP AG

(21) Appl. No.: 14/318,959

(22) Filed: Jun. 30, 2014

(51) Int. Cl. G06Q 30/02; G06F 17/30

(52) U.S. Cl. CPC G06Q 30/0276; G06F 17/30592; G06F 17/30864

(57) ABSTRACT

A system, a method, a device, and a computer program product for single sheet planning of business objects are provided. A trade promotion data relating to at least one product is generated. Based on the generated trade promotion data, data stored in a database is queried. The data relates to at least one parameter associated with the generated trade promotion data. Based on the querying, a trade promotion planning data for the at least one product is generated

### TECHNICAL FIELD

This disclosure relates generally to data processing and, in particular, to single sheet planning for business objects with online analytical processing (“OLAP”).

### BACKGROUND

Online analytical processing (“OLAP”) is part of business intelligences and provides a way to answer multi-dimensional analytical queries. OLAP includes relational databases, report writing and data mining. Some of the typical applications of OLAP can include business reporting for sales, marketing, management reporting, business process management, budgeting and forecasting, financial reporting, etc.

OLAP enables analysis of multidimensional data interactively from multiple perspectives and includes the following analytical operations: consolidation, drill-down, and slicing and dicing. Consolidation operation includes aggregation of data that can be accumulated and computed in one or more dimensions. Drill-down operation allows users to navigate through the details. Slicing and dicing operation allows users to take out (“slice”) a specific set of data of an OLAP cube (i.e., an array of data having zero or more dimensions, e.g., a spreadsheet) and view (“dice”) the slices from different viewpoints. Databases that are configured for OLAP use a multidimensional data model, which permits complex analytical and ad hoc queries with a rapid execution time.

A business object is an intelligible entity inside a business layer in an n-layered architecture of object-oriented computer programs. A business object can hold instance variables or properties, i.e., attributes, and associations with other business objects, creating a map of objects representing the business relationships. Business objects are communicated across tiers in a multi-tiered system, while the real work of an application can be performed in a business tier and does not move across the tiers.

However, conventional business systems suffer from poor usability of maintaining business object attributes along with the related planning data that can be residing in the OLAP system. Typically, the attributes and planning data is maintained separately. This can cause slower performance in execution of maintenance of business objects' attributes and planning data. Further, it may be difficult to create an overview of all data needed for performing planning activities and maintaining business objects' attributes. Thus, there is a need for a planning system for business objects that can include an OLAP integration.

### SUMMARY

In some implementations, the current subject matter relates to a computer-implemented method for single sheet planning of business objects. The method can include generating a trade promotion data relating to at least one product, querying, based on the generated trade promotion data, data stored in a database, wherein the data relates to at least one parameter associated with the generated trade promotion data, and generating, based on the querying, a trade promotion planning data for the at least one product. At least one of the generating the trade promotion data, the querying, and the generating the trade promotion planning data can be performed on at least one processor of at least one computing system.

In some implementations, the current subject matter can include one or more of the following optional features. The method can include arranging the generated trade promotion planning data in a single user interface, and displaying the arranged generated trade promotion planning data in the single user interface. The single user interface can include a spreadsheet containing a plurality of data cells.

In some implementations, the trade promotion planning data can include trade promotion planning data for a plurality of products. The trade promotion planning data can be grouped into at least one group based on at least one trade promotion planning parameter. The trade promotion planning data can be generated for the plurality of products simultaneously.

In some implementations, at least one database can be located in a business warehouse storing at least one key figure parameter associated with at least on promotion planning data. The single user interface can communicate with the business warehouse using a planning connector for performing at least one of the querying, the generating the promotion planning data, the arranging, and the displaying.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1a illustrates an exemplary system for trade promotion management, according to some implementations of the current subject matter;

FIG. 1b illustrates an exemplary process for trade promotion planning, according to some implementations of the current subject matter;

FIG. 2 illustrates an exemplary business warehouse system implemented by a business entity, according to some implementations of the current subject matter;

FIG. 3 illustrates an exemplary implementation of a planning group, according to some implementations of the current subject matter;

FIG. 4 illustrates an exemplary multiple planning scenario, according to some implementations of the current subject matter;

FIG. 5 illustrates an exemplary trade promotion planning process, according to some implementations of the current subject matter;

FIGS. 6a-6c illustrate various options of implementing the mass planning controller, according to some implementations of the current subject matter;

FIG. 7 illustrates an exemplary process for performing planning operations, according to some implementations of the current subject matter;

FIG. 8 illustrates an exemplary single-sheet trade promotion planning interface, according to some implementations of the current subject matter;

FIG. 9 illustrates an exemplary computing system, according to some implementations of the current subject matter;

FIG. 10 illustrates an exemplary software architecture, according to some implementations of the current subject matter;

FIG. 11 is an exemplary system, according to some implementations of the current subject matter; and

FIG. 12 is an exemplary method, according to some implementations of the current subject matter.

### DETAILED DESCRIPTION

To address these and potentially other deficiencies of currently available solutions, one or more implementations of the current subject matter provide methods, systems, articles or manufacture, and the like that can, among other possible advantages, provide systems, methods, and computer program products for providing a single sheet planning for business objects with an online analytical processing (“OLAP”).

In some implementations, the current subject matter can provide a single sheet planning for business objects that can allow for an enhanced usability to plan several business objects by maintaining multiple attributes and planning data despite the date residing in different data sources. The current subject matter can also personalize data layout and provide an offline calculation engine to simulate the OLAP calculation to provide flexibility and a better performance experience. In some implementations, the current subject matter can further provide flexible integration between several data sources to seamlessly combine different types of data with multiple cardinality in a single view. The current subject matter can perform mass management of business objects and related planning data, including viewing, creating, and maintenance.

In some implementations, the current subject matter can enable planning of multiple business objects at the same time, maintaining not only attributes but also planning data residing in an OLAP system as well as planning a single business object at a time, including attributes and/or planning data. The current subject matter can further enable maintenance of different types of data simultaneously. Further, users of the current subject matter can personalize their user interface layouts to show only relevant information for a particular task. Additionally, multiple offline calculations for simulating an OLAP calculation and improving overall system performance can be performed. In some implementations, the current subject matter can provide asynchronous processing to allow submission of data for validation purposes while performing other tasks at the same time.

In some implementations, the current subject matter can perform trade promotion management (“TPM”) and can allow a key account manager (“KAM”) associated with a business entity to plan and manage various trade promotions that can be offered to business entity's customers. The trade promotions can be selected by KAM and managed using a single interface. In some implementations, such management of trade promotions can be accomplished through use of various spreadsheet software, user interface, and/or computer programs (e.g., Microsoft Excel®, etc.). In some implementations, KAM can perform sales forecasting, promotion planning and budgeting, predictive modeling/optimization, trade promotion execution and monitoring, settlement, post event analysis, and/or any other operations.

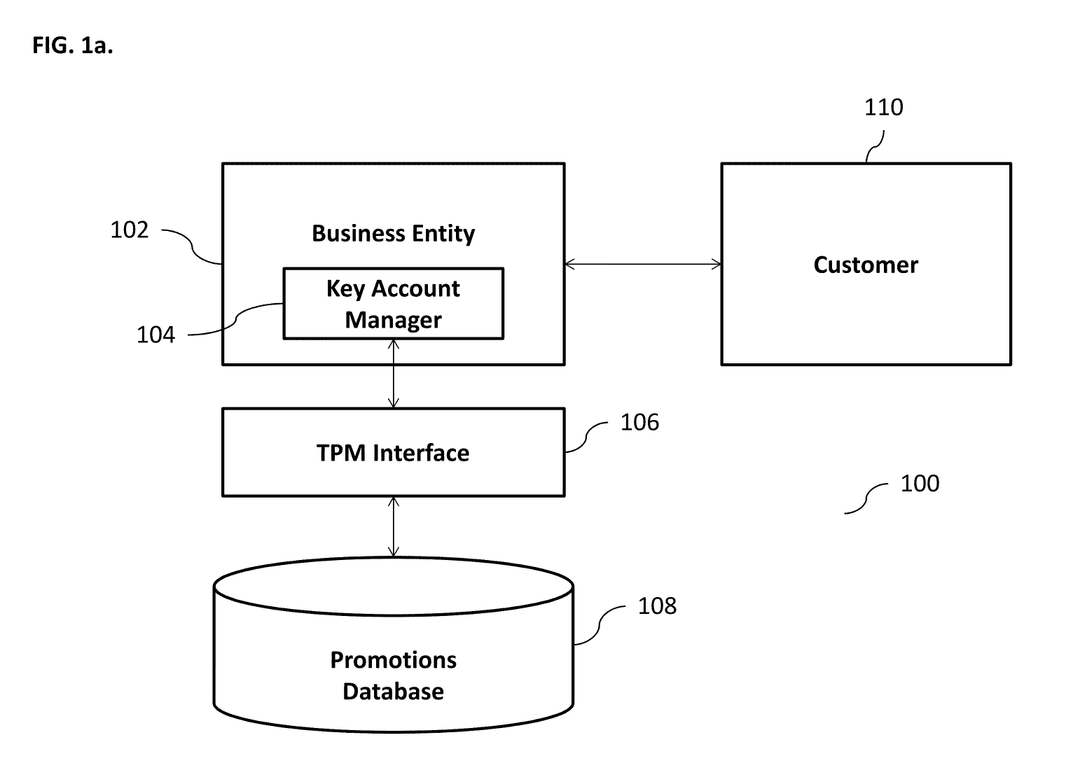

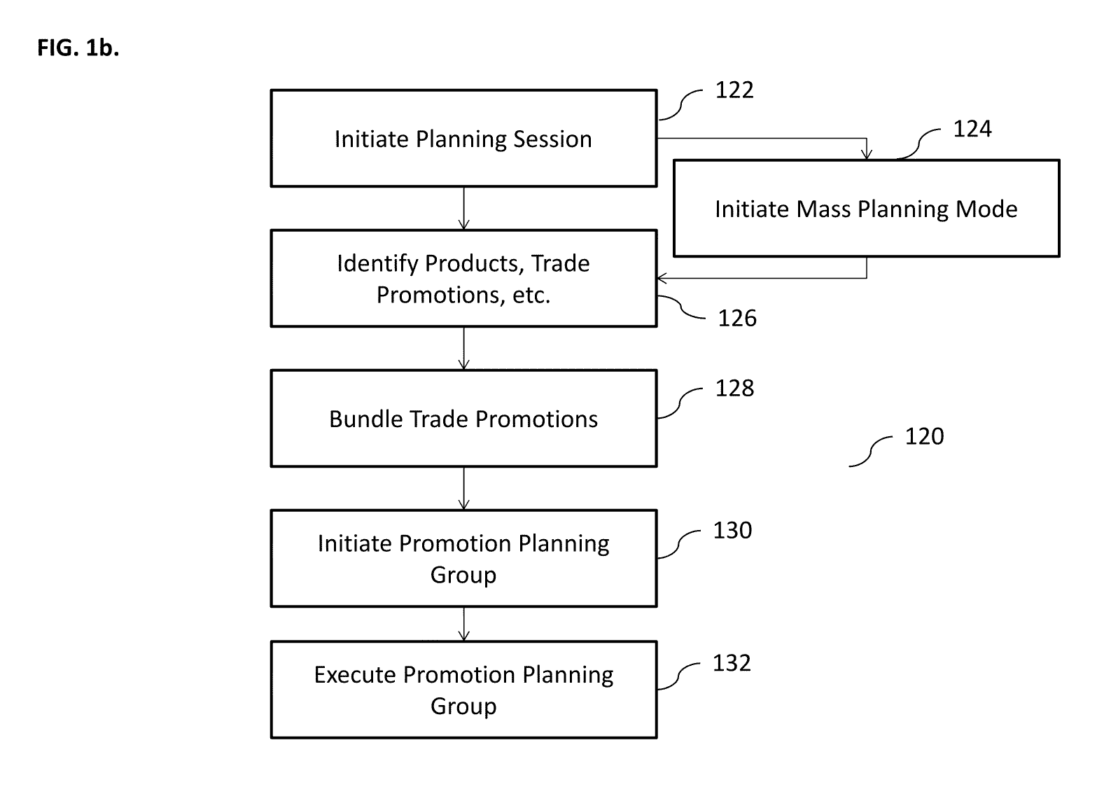

FIG. 1a illustrates an exemplary system 100 for trade promotion management, according to some implementations of the current subject matter. The system 100 can include a business entity 102 that can have at least one key account manager 104. The business entity 102 can be any commercial, governmental, private, public, etc. entity that can provide various products and/or services to its customers 110. Customers 110 can likewise be any commercial, governmental, private, public, etc. entities. The entity 102 can also generate various trade promotions related to its products and/or services. The trade promotions can be related to a price of the products/services, new products/services, special offers, specific time offers, and/or any other type of offers. The trade promotions can be stored in a promotions database 108.

In some implementations, the key account manager 104 can be responsible for management of sales, trade promotions and/or relationship with customers or specific customer and/or group of customers. The KAM 104 can be an individual and/or a business unit associated with the business entity 102. The KAM 104 can select, group, manage, etc. various trade promotions for offering to the customers 110 using a trade promotion management (“TPM”) interface 106. The TPM interface 106 can allow the KAM to easily perform these operations in a single “sheet”. The single sheet can be a single user interface that can allow the KAM 104 to perform various operations associated with trade promotions creation, generation, management, etc. The operations can include working with multiple trade promotions in a single session, displaying and changing planning data (key figures), displaying products as rows in trade promotion list with expand/collapse possibilities, adding/removing products from trade promotion lists, displaying and changing dates of trade promotions, displaying and changing customer relationship management (“CRM”) rates and business intelligence (“BI”) rates, displaying and changing status of trade promotions, copying trade promotions, and/or any other operations.

In some implementations, trade promotions that can be offered by the business entity can be stored in a storage location, such as a business warehouse (“BW”) (e.g., NetWeaver Business Warehouse, by SAP AG, Walldorf, Germany). The trade promotions can be stored in the BW as various planning objects that can be called or queried by a user (e.g., KAM) for the purposes of creating promotional offerings to customers, which can be managed and/or presented using a single sheet. In some implementations, to create a promotional offering, the user (e.g., a KAM) can issue a query to the business warehouse, which can specify products, prices, trading information, sales figures, previous discounts, and/or any other parameters that can be used to obtain promotional data. The data can be general and/or customer specific and/or product specific. The query can return planning data related to the available trade promotions and can allow the user to perform various mass planning operations that can result in generating a listing of various trade promotions on a single sheet. In some implementations, a single query to the BW can return all trade promotions (i.e., planning objects) to the user, where each trade promotion can be associated with a different planning profile group. The planning profile group can group various promotions (i.e., planning objects) by various criteria, e.g., time, product type, product category, customer, discount, etc.

FIG. 1b illustrates an exemplary process 120 for trade promotion planning, according to some implementations of the current subject matter. At 122, a planning session can be initiated. A key account manager 104 (shown in FIG. 1a) can initiate such trade promotion planning session. The session can be initiated by opening a trade promotion planning application, issuing a query to the business warehouse, and/or performing any other actions. Once the planning session has been initiated, the key account manager 104 can identify products, trade promotions, types of products, changes to the current trade promotions, etc. This information can be supplied to the promotion planning application manually (e.g., by KAM), automatically, and/or in any other fashion. At 124, a mass planning mode can also be initiated. This can be done manually, automatically, and/or in any other way. In some implementations, the initiations of the mass planning mode can be hidden from KAM. The mass planning mode can allow management of a plurality of trade promotions at the same time. At 128, the trade promotions can be bundled. At 130, a promotion planning group can be initiated, and executed, at 132. In some implementations, the bundling and grouping can be performed for the purposes of efficiently executing operations on the trade promotions, such as reading, changing, etc.

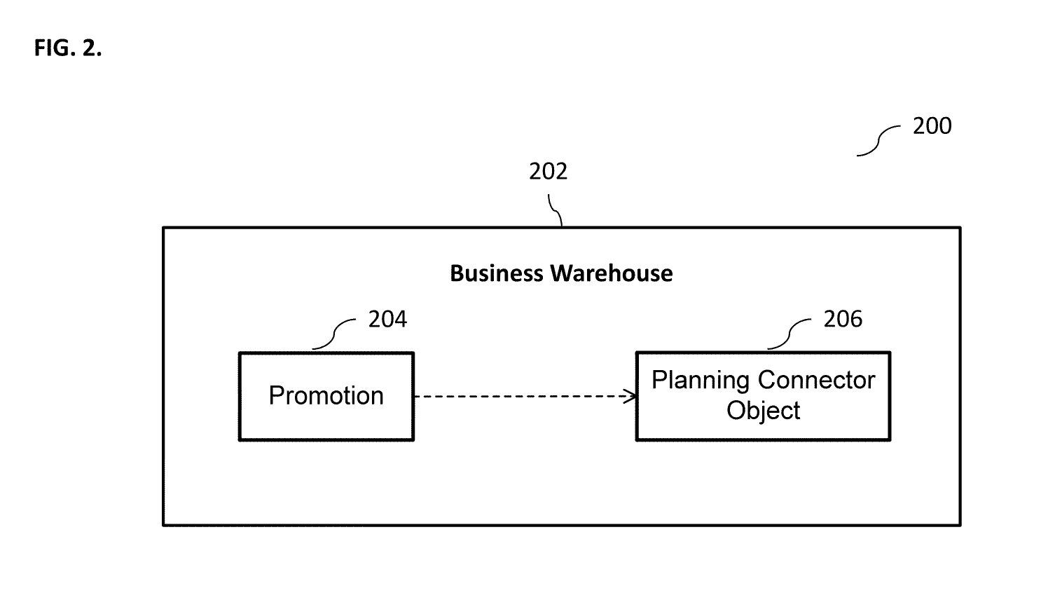

In some implementations, each promotion can be stored as an object in a business warehouse. FIG. 2 illustrates an exemplary system 200 that can be implemented or used by a business entity (e.g., business entity 102 shown in FIG. 1). The system 200 can include a business warehouse 202. The business warehouse 202 can include at least one trade promotion or planning object 204, where each such trade promotion 204 can be associated with a planning object connector 206. The trade promotion 204 can be an instance of a trade promotion management planning service manager (“TPM PSM”). In some implementations, the trade promotion can be a business object, which can a multitude of information, including information that is not planning related, e.g., customer contacts, marketing material attachments, etc. The planning object can be an object that can represent planning aspects of a trade promotion. The planning connector can be an interface to the application and the manager of the planning objects.

The PSM can be used to execute automated planning tasks, which can be grouped. The typical planning tasks can include at least one of the following: forecast, replenishment planning, Transport Load Builder (“TLB”). The tasks can also be grouped in a planning profile. In some implementations, the planning profile can be used to identify a planning context, e.g., which OLAP query, characteristics, key figures, planning functions, etc. can be available to the user. A “planning profile group” can be a semantic grouping of planning profiles, e.g., one group for “long-term marketing planning”, one group for “free goods planning”, etc. Upon execution of the planning profile, all planning tasks within it are executed and the results can be stored. The PSM can carry out planning tasks using planning services, which can include at least one of the following: a forecast service, a replenishment service, a TLB service, etc. Using data managers, the planning services access master data, transaction data (e.g., orders, time series, stock, etc.), alerts, and/or any other data. As a result, new and/or changed data can be stored in a database. Planning services and service profiles for the PSM can be prepared by the applications. In some cases, every planning service can have a service profile where parameters such as model, planning horizon, time series, etc., can be set so that a system use them during a planning run. In some implementations, during runtime, PSM with a planning profile can be called. In the planning profile, specific planning steps can be executed in appropriate process blocks. The PSM can call up the planning services (such as the forecast service, the replenishment service, the storage service, etc.) in sequence, as defined in the planning profile. The storage service can call up the data managers that are responsible for reading and buffering time series, orders, and master data, for example.

A planning profile can include a header data and one or more process blocks. The header data can contain administrative information for the planning profile, such as who created or changed the planning profile, and when. Process blocks can follow the header data, and can include identification of the planning context, e.g., which OLAP query, characteristics, key figures, planning functions, can be available to the user in every process block. Every planning service can have a service profile that is prepared by the respective application.

The PSM can create packages of planning objects for every process block from the selection and planning version defined. The PSM creates packages using the package creation method defined in the process profile. The packages can be processed in sequence or in parallel. Parallel processing, which can be performed at a lower level, can improve performance. The PSM executes the planning services from the service list separately for each package.

Referring back to FIG. 2, the planning connector object 206 can be an instance of an interface related to customer relationship management (“CRM”) implementation session interface. The objects can be registered in the planning connector session that can handle multiple objects. In some implementations, each planning object (i.e., trade promotion) 204 can correspond to its own planning connector object 206 in the business warehouse 202.

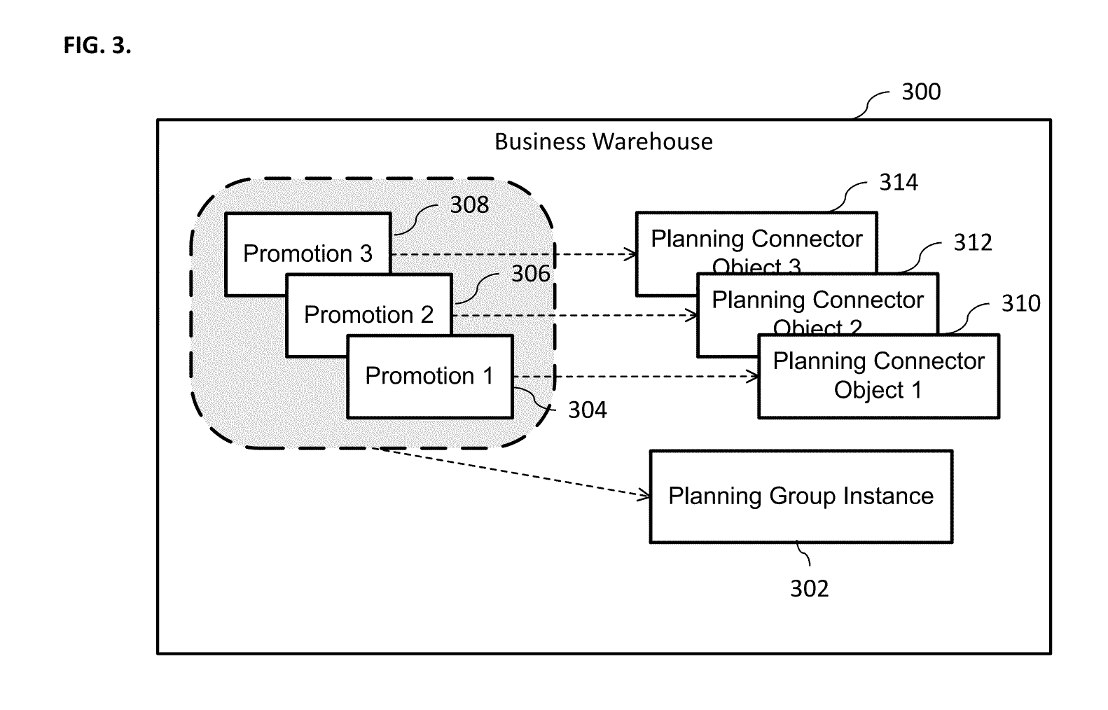

In some implementations, to enable an application to work in mass mode, i.e., handling multiple different promotions, a promotions planning group can be used. FIG. 3 illustrates an exemplary implementation of a planning group. A business warehouse 300 can include multiple promotions 304, 306, 308, where promotion 304 can correspond to a planning connector object 310, promotion 306 can correspond to a planning connector object 312, and a promotion 308 can correspond to a planning connector object 314. The promotions 304, 306, 308 can be grouped together into a planning group instance 302. The planning group instance 302 can handle group related operations, which can include, for example, query execution for the single-sheet planning, updating key figure values (e.g., “=update cell”), triggering synchronization for the planning group instance, as well as any other operations. Any control data for any changes to the planning combinations can be sent through the business application that is used for trade promotion planning. In some implementations, the business application might not be aware of the multi-planning scenario. Once all planning objects have published their change requests, the planning group can be called to trigger its execution and the object contained in it.

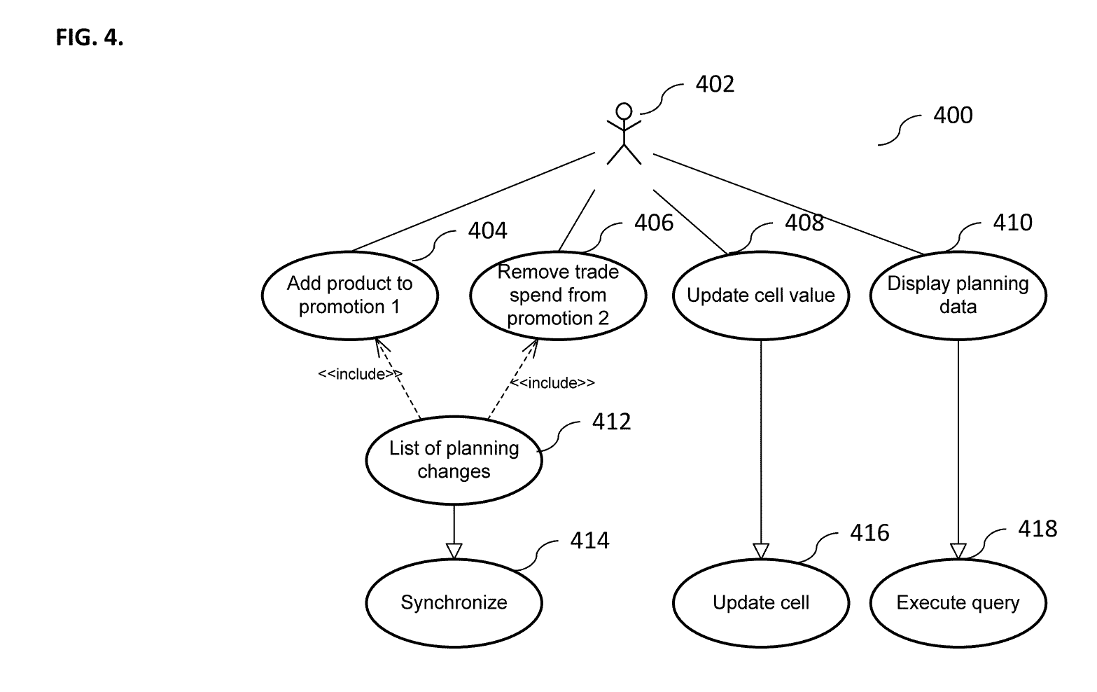

FIG. 4 illustrates an exemplary multiple planning scenario 400, according to some implementations of the current subject matter. In some implementations, a KAM 402 can initiate a process of trade promotion planning, where trade promotions can be added, deleted, changed, etc. Further, products can be added, deleted, updated, etc. in the trade promotions group. For example, the KAM 402 can use various software, computer programs, spreadsheet programs, user interface, etc. (e.g., Microsoft Excel, etc.) to perform a single sheet trade promotion planning. The programs can include a plurality of cells that can be used to indicate product information, trade promotions, prices, discounts, categories of products, customers, etc. At 404, the KAM 402 can initiate addition of a product to trade promotion 1. At 406, the KAM 402 can initiate removal of a trade spending parameter from promotion 2. A list of planning changes can be generated, at 412, and synchronized in the BW, at 414. At 408, cell values in the spreadsheet containing trade promotions can be updated by the KAM, which can cause an update operation in the BW, at 416. The KAM 402 can request a display of the updated planning data, at 410, which will execute an appropriate planning query in BW to generate the updated planning data for display to the KAM, at 418. The operations 412-418 can be performed at BW and can be bundled at BW as well.

In some implementations, once a trade promotion planning session has been activated, a mass planning mode (as shown in FIG. 1b), can be initiated. The mass planning mode can allow the planning connector objects (e.g., planning connector objects 310-314, as shown in FIG. 3) to work with different trade promotions. The mass planning mode can be activated automatically as soon as there is an indication that a single planning session will involve more than one planning object, and/or manually by the user/application, and/or in any other fashion.

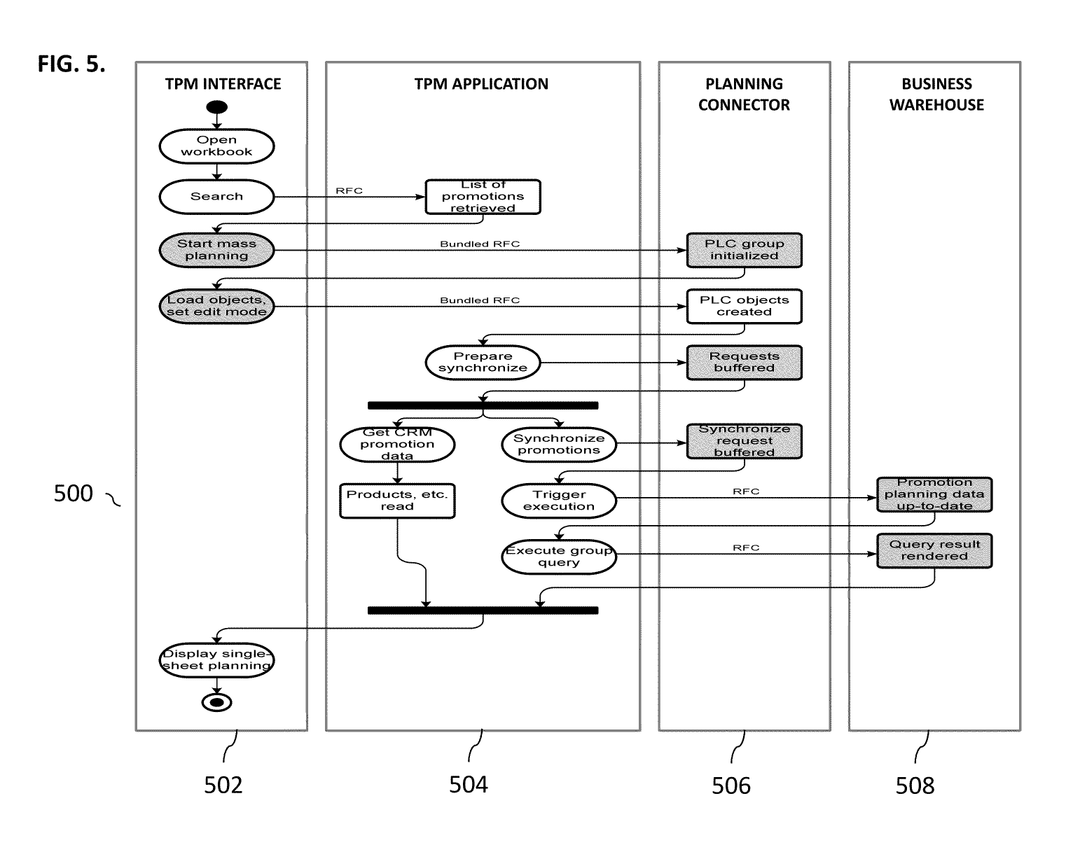

FIG. 5 illustrates an exemplary trade promotion planning process 500, according to some implementations of the current subject matter. The process 500 can be performed using a trade promotion management application interface (e.g., Microsoft Excel, etc.) 502, a TPM application 504, a planning connector 506, and a business warehouse 508. The user (e.g., a KAM) can use the interface 502 to access the TPM application 504. The TPM application 504 can communicate with the business warehouse 508 via the planning connector 506 to obtain data responsive to queries received from the user that accessed the TPM application 504 via the interface 502. The planning connector 506 can be part of the customer relationship management.

As shown in FIG. 5, the user can open a workbook in the TPM interface 502 and search for trade promotions, products, product categories, performance indicators, customers, sales information, and/or any other information that may be relevant to the trade promotion planning. Trade promotion planning can be for a single customer and/or a plurality of customers. The user can further plan trade promotions for one product and/or multiple products, where the products can be related and/or unrelated to one another. Similarly, the user can plan trade promotions for services, products, and/or services and products. For ease of description and illustration purposes only, the following discussion will refer to trade promotion planning for products.

Once the user has initiated a search for products, the TPM application 504 can be contacted (e.g., via any generic communication protocol, such as a remote function call (“RFC”)). The TPM application can retrieve a list of promotions for display to the user. Once the promotions are displayed, a mass planning mode can be initiated by issuing a bundled RFC to the planning connector 506 to initialize a planning connector group. The planning connector 506 can then provide the planning objects (e.g., promotions) to the user (at the TPM interface 502) for editing/creating. Once the trade promotions are created/edited/etc., a bundled RFC is sent to the planning connector 506. The planning connector 506 can create the planning connector objects and provide them to the TPM application 504. The TPM application 504 can prepare for synchronization of the user entered trade promotions with the data in the business warehouse 508. After buffering appropriate requests by the planning connector 506, the TPM application 504 can obtain CRM promotions data and read corresponding products, sales, etc. information. At the same time, the TPM application can also synchronize trade promotions data and, after buffering synchronization requests by the planning connector 506, can trigger execution of a promotion planning query at the business warehouse 508. The business warehouse 508 can ensure that the trade promotion data is up to date. Once the query is executed on the business warehouse data, the business warehouse 508 can return the results of the query to the TPM application. The TPM application 504 can then generate a single sheet containing all trade promotions for which the data was requested and display the sheet at the TPM interface 502.

In some implementations, the mass planning of trade promotions can be performed using a mass planning controller. The mass planning controller can be a business process that can be performed using a processor and a memory. Each of the mass planning controller used by the TPM application, the planning controller, and/or the business warehouse can be used to perform mass planning of trade promotions.

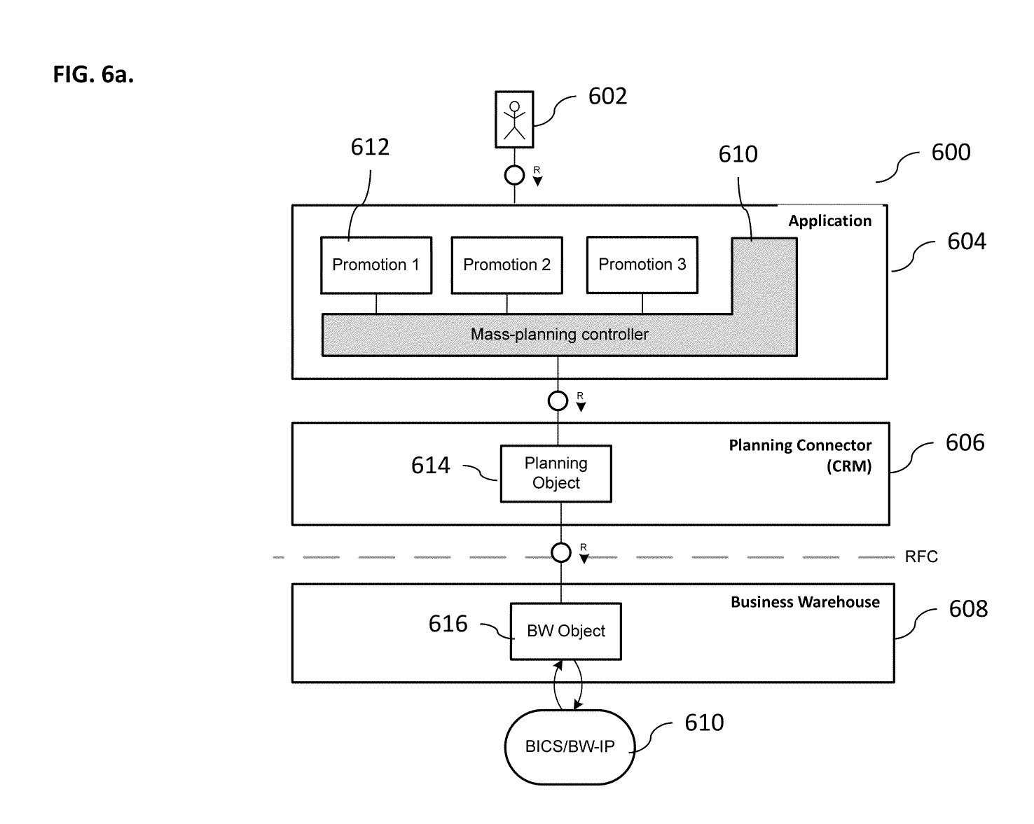

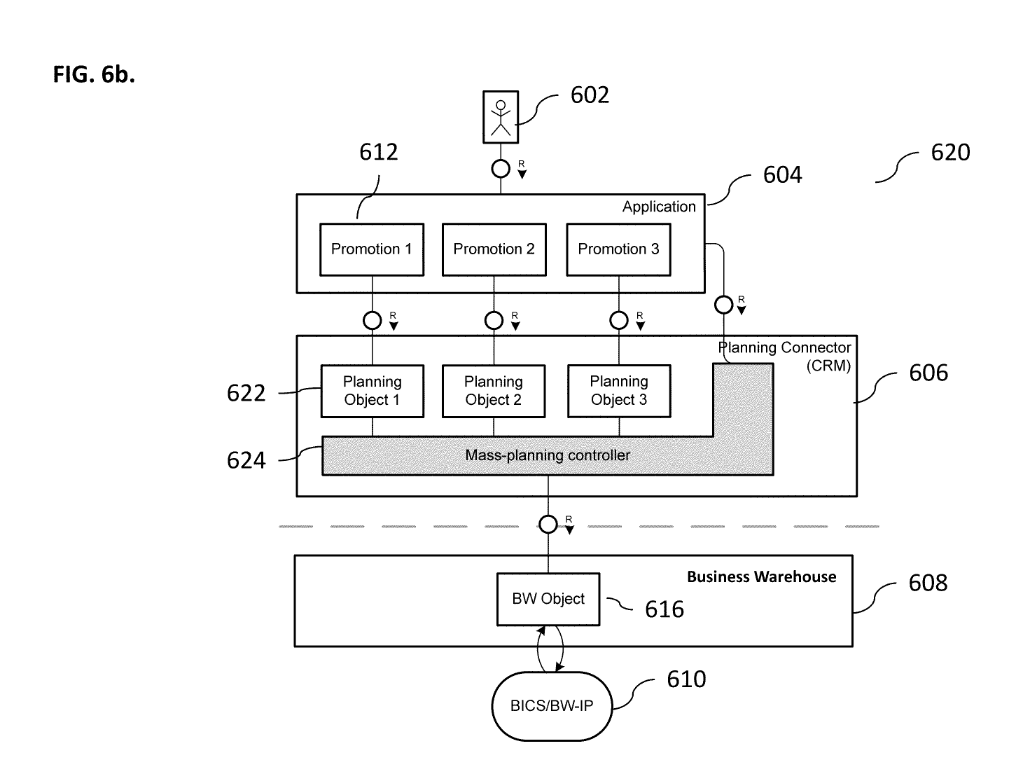

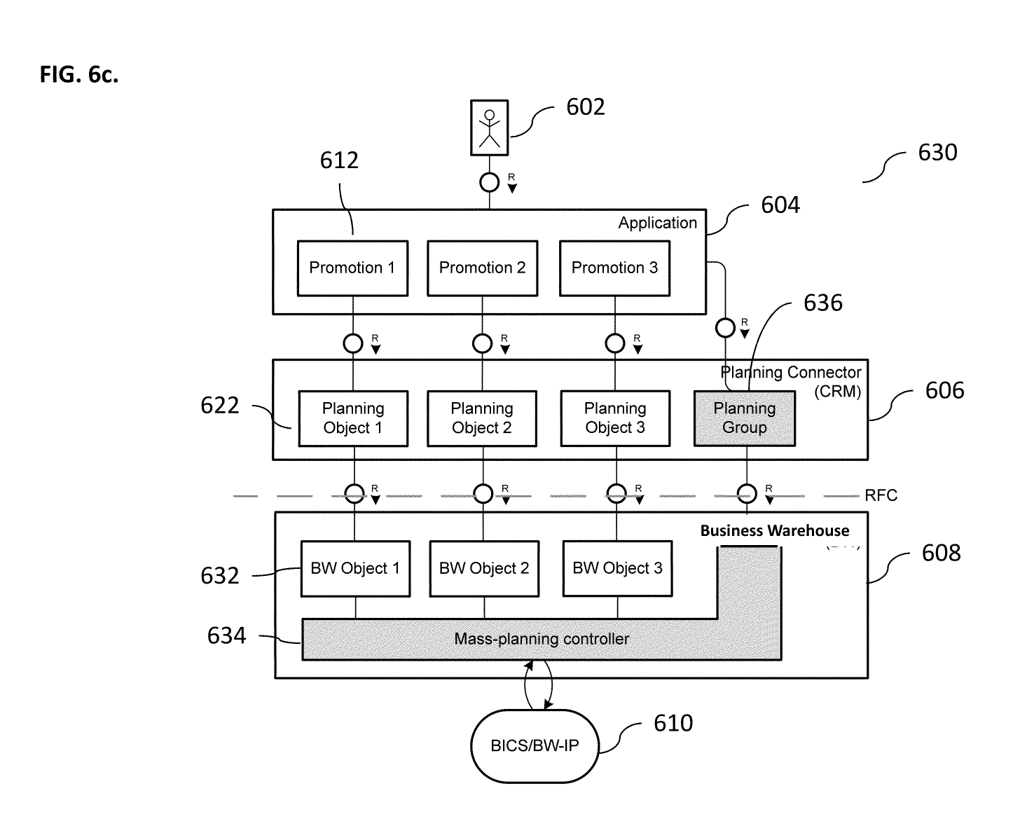

FIGS. 6a-6c illustrate various exemplary options of implementing the mass planning controller. These are provided for illustrative purposes only and are not intended to limit the subject matter disclosed herein. FIG. 6a illustrates an implementation of the mass planning controller in the application, whereby the application can manage all bundling and work with a single planning connector object. FIG. 6b illustrates an implementation of the mass planning controller in the planning connector/CRM layer, whereby the planning connector layer can bundle calls from the application and work with a single business warehouse planning object. FIG. 6c illustrates an implementation of the mass planning controller in the business warehouse, which take cares of the bundling. Each of these is discussed in more detail below.

FIG. 6a illustrates an exemplary mass planning process 600 performed between an application 604, a planning connector 606, and a business warehouse 608, according to some implementations of the current subject matter. A user 602 can be configured to interact with the application 604 by searching for promotions 612. The application 604 can include a mass planning controller application 610 that can bundle the trade promotions 612 and provide the bundled promotions 612 (for example as a planning group instance) to the planning connector 606. The planning connector 606 can generate a planning object 614 based on the received bundled trade promotions from the application 604. The planning connector 606 can then provide the planning object (via a remote function call) to business warehouse 608, which can in turn, generate a business warehouse object 616. The business warehouse 608 can then interact with business intelligence consumer services (“BICS”) 610.

FIG. 6b illustrates an exemplary mass planning process 620 performed between the application 604, the planning connector 606, and the business warehouse 608, according to some implementations of the current subject matter. Similar to the process 600 shown in FIG. 6a, the user 602 can be configured to interact with the application 604 by searching for trade promotions 612. The trade promotions 612 can then be provided by the application 604 to planning connector 606, which can generate respective planning objects 622. The application 604 can also provide information about the trade promotions to a mass planning controller 624, which can be disposed at the planning connector 606 and can bundle the planning objects 622. After bundling, the mass planning controller 624 can provide the bundled objects 622 to the business warehouse 608 for generating the business warehouse object 616. The business warehouse 608 can then interact with BICS 610.

FIG. 6c illustrates an exemplary mass planning process 630 performed between the application 604, the planning connector 606, and the business warehouse 608, according to some implementations of the current subject matter. Similar to FIG. 6b, the user 602 can interact with the application 604 by searching for trade promotions 612. The application 604 can provide the trade promotions 612 to the planning connector 606, which can generate respective planning objects 622. The planning connector 606 can also include a planning group object 636. The planning objects 622 and the planning group object 636 can be provided (via a remote function call) to the business warehouse 608. The business warehouse 608 can generate respective business warehouse objects 632 for each planning object 622. The planning group object 636 can be supplied to a mass planning controller application 634 that can bundle the business warehouse objects 632. The mass planning controller 634 in the business warehouse 608 can then interact with BICS 610.

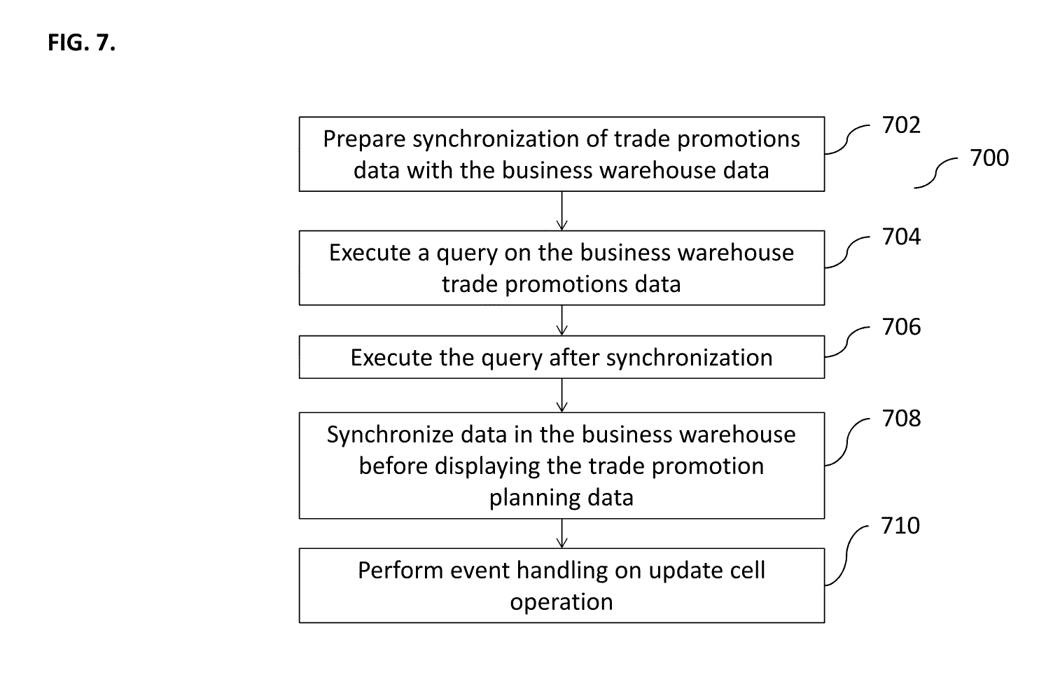

FIG. 7 illustrates an exemplary process 700 for performing planning operations, according to some implementations of the current subject matter. The planning operations process 700 can include preparation of synchronization of trade promotions data with the business warehouse data 702, execution of a query on the business warehouse trade promotions data 704, execution of the query after synchronization 706, synchronization of data in the business warehouse before displaying the trade promotion planning data 708, and/or performing event handling on update cell operation 710. Each of these operations is discussed in further detail below. Further, in some implementations, the current subject matter process 700 can involve the following exemplary scenarios. One of the exemplary scenarios can include changing/creating a key of a planning record, e.g., adding a product. This can be accomplished by preparing synchronization, execute synchronization, performing any additional manipulation before query execution, executing the query, and performing any after-query processing. Another exemplary scenario can include changing a value of an existing record (not a key value). This can be performed by setting a new value (e.g., update cell), performing any additional manipulation before query execution, executing the query, and performing any after-query processing.

In some implementations, the preparation of synchronization of trade promotions data in the business warehouse 702 can be perform (automatically and/or manually) when the user is sets the trade promotion planning interface into an edit mode, i.e., when the user determines that a trade promotion needs to be updated (e.g., add a product, change quantity, changer price, remove a product, etc.). This operation can be performed using PREPARE_SYNCHRONIZE operation. In some implementations, this operation can be executed for all trade promotions and/or for some trade promotions. In some implementations, prepare synchronize operation can be executed on a per-object. The operation can call its actions service instance, which can forward the call to the service state implementation (where each object has its own instance). The following code can be executed:

| | |
|---|---|
| mo_service_state−>prepare( iv_query_id | = iv_query_id |
| it_metadata | = it_metadata |
| it_dataset_selection | = it_dataset_selection |

The above operation can include the following calls:

load_static_planning_functions( iv_query_id = iv_query_id

iv_event_id =
cl_rscrm_imp_constants=>event_after_synchronization
iv_transient_relation = abap_true ).

| | |
|---|---|
| prepare_lead_obj_master_data( | it_metadata = it_metadata |
| | it_dataset_selection = |
| | it_dataset_selection ). |

In some implementations, the static planning functions do not depend on the object, and can be executed once for all trade promotions. In some implementations, the PREPARE_SYNCHRONIZE operation can be executed after executing the query on the business warehouse so that at least the user interface can have data to be displayed and would not to need to wait for the remote function calls to be completed.

In some implementations, the execution of the query on the business warehouse data 704 can include execution of a multi-planning query. For such execution, the query can use at least one identifier associated with at least one trade promotion or all identifiers of all trade promotions. The query can implement use of any other parameters that may be needed to set the planning query into an edit mode and can include a query definition, various compounding information, business partner data, sales organization information, business add-ins (“BADI”, as developed by SAP AG, Walldorf, Germany), and/or any other parameters. In some implementations, the planning connector objects can contain query filter data, a planning model, visible key figures, etc. The objects can be initialized by the TPM application and can be used to execute the planning query.

In some implementations, the execution of the query after synchronization 706 can be performed to execute any custom logic that may be associated with the process 700. This operation can be performed by the user from the user interface clicking an appropriate button (or link). In a default mode, this command can trigger the query execution asynchronously. However, if another remote function call is still running (e.g., synchronize), the query is not triggered, because only one asynchronous remote function call can be executed at any point in time. Hence, as a result, the user interface can later request the query data and the remote function call to business warehouse can be executed synchronously, i.e., the main process can wait for it to be completed.

In some implementations, the synchronization before displaying planning data operation 708 can be used to perform synchronization of promotion data before navigating to the planning screen. This can ensure that information which is stored outside the trade promotion planning cube, for example, list price (from CRM) and baseline (from another BW cube), can be updated before starting planning. It can also ensure that the characteristic relationships are correctly set to enable planning for the trade promotion. In some implementations, this operation can perform optimization by combining several planning functions, which are triggered on the synchronize event and only execute them once for all trade promotions. For example, combining “set key figure values” planning function for the key figures sent from CRM (e.g., list price, trade spends, etc.) can generate an improved performance. Further, the synchronization operation 708 can implement an enhanced save operation which can disable synchronization on save if no changes are done to a trade promotion. This can be based on an assumption that external changes have been reflected by an external process in the trade promotions (e.g., batch jobs that automatically update the trade promotions on change of list price or baseline, etc.).

In some implementations, the operation of event handling on update cell 710 can include a simple cell update, a cell update with buying pattern enabled, a cell update without/with buying pattern enabled, etc. (which can depend on a specific customer and their associated business process(es)). These cell updates can be performed on various cells of a single sheet spreadsheet that contains trade promotions data that the user is working on. One of the functions that can be performed when updating cell values is calculation of key figures. This planning function can be applied to all trade promotions (in mass-processing execution mode) in the selection criteria in one single execution. It can compare key figures for all trade promotions that are being updated with key figures calculation planning function which can be triggered individually for every trade promotion in the selection (in regular-processing execution mode).

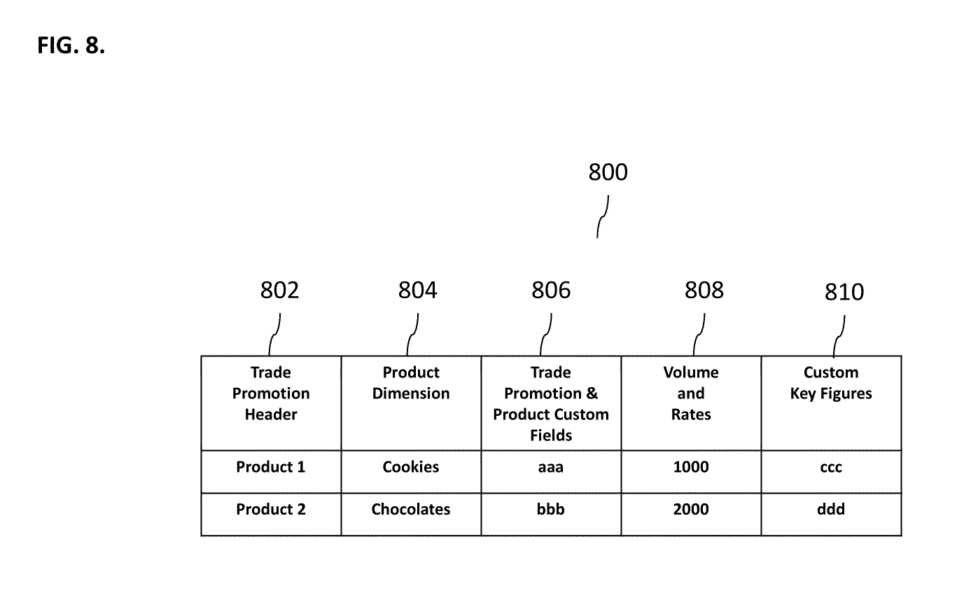

FIG. 8 illustrates an exemplary single-sheet trade promotion planning interface 800 that the user (e.g., KAM) can use to create, update, delete, manage, etc. various trade promotions for one or more customers of a business entity with which the user is associated, according to some implementations of the current subject matter. The interface 800 is not limited to the one shown in FIG. 8 and can contain more or less information and can be customized to the user's desires. The interface 800 can include one or many products and/or one or many trade promotions. The shown interface 800 is for illustrative purposes only and is not intended to limit the scope of the subject matter disclosed herein. In some exemplary implementations, the interface 8 can include more than 25 columns and more than 25 rows of data related to trade promotion planning. As shown in FIG. 8, the interface 800 can include a trade promotion header column 802, a product dimension column 804, a trade promotion and customer fields column 806, a volume and rates column 808, and custom key figures column 810. Each column 802-810 can include one or more sub-columns (not shown in FIG. 8) for providing any additional information about trade promotions, products, prices, etc.

The trade promotion header column 802 can include an identification of a product, e.g., a name of the product, a specific product identifier, a customer identifier, a trade promotion identifier, an objective (e.g., product introduction), dates of trade promotions, identification of a planning group associated with the product and/or promotion, and/or any other information. FIG. 8 includes “Product 1” and “Product 2” in the trade promotion header column 802, however, it is understood that the above information along with any other information can be included in column 802. The user can edit the information contained in the column 802 by adding and/or removing and/or updating products and/or any other data (e.g., “Product 1”, “Product 2”, etc.). When editing the information about products, the current subject matter can perform one or more processes shown and discussed above in connection with FIGS. 1a-7.

The product dimension column 804 can include information about the product for which trade promotion is being edited and/or listed on the single sheet planning spreadsheet 800. The information can identify what the product is (e.g., “Cookies”, “Chocolates”, etc.). It can also identify what the product groups are for a particular product that can be associated with a particular customer. Additionally, it can identify a planning profile group, and/or any other data. If the user desires to edit information in this column, the current subject matter system can perform one or more processes shown and discussed above in connection with FIGS. 1a-7.

The trade promotion and product custom fields column 806 can include various information about the products and/or trade promotion that the user desires to enter. Again, if the user desires to edit information in this column, the current subject matter system can perform one or more processes shown and discussed above in connection with FIGS. 1a-7.

The volume and rates column 808 can include a volume of a product being offered in connection with a particular trade promotion for that product (e.g., “1000”, “2000”, etc.). The column 808 can also include information about promotional discount rates for a particular product (e.g., 5%, 3%, etc.). Similar to the columns 802-806, if the user desires to edit information in this column, the current subject matter system can perform one or more processes shown and discussed above in connection with FIGS. 1a-7.

Custom key figures column 810 can include information that may be associated with customers, products, etc. for which a particular trade promotion is being offered. This can include various formulae that may be used in determining what the trade promotion can be for a particular customer, product, etc. The information can also include prior purchasing history, previous discounts, customer spending habits, etc. This information can be provided by the user and the current subject matter system can include this information in performing one or more processes shown and discussed above in connection with FIGS. 1a-7.

In some implementations, the current subject matter can be implemented in various in-memory database systems that can require its users to have authorization profiles for the purposes of accessing data in such systems. As stated above, an example of such in-memory database systems includes High Performance Analytic Appliance (“HANA”) system as developed by SAP AG, Walldorf, Germany. Various systems, such as, enterprise resource planning (“ERP”) system, supply chain management system (“SCM”) system, supplier relationship management (“SRM”) system, customer relationship management (“CRM”) system, and/or others, can interact with the in-memory system for the purposes of accessing data, for example. Other systems and/or combinations of systems can be used for implementations of the current subject matter. The following is a discussion of an exemplary in-memory system.

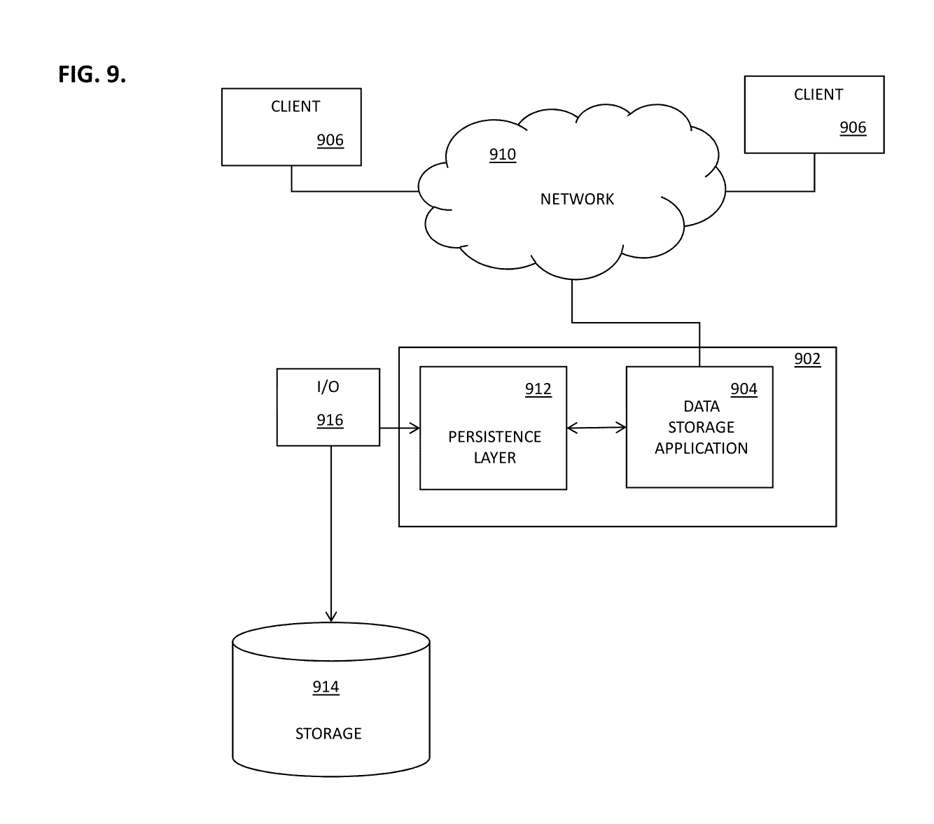

FIG. 9 illustrates an exemplary system 900 in which a computing system 902, which can include one or more programmable processors that can be collocated, linked over one or more networks, etc., executes one or more modules, software components, or the like of a data storage application 904, according to some implementations of the current subject matter. The data storage application 904 can include one or more of a database, an enterprise resource program, a distributed storage system (e.g. NetApp Filer available from NetApp of Sunnyvale, Calif.), or the like.

The one or more modules, software components, or the like can be accessible to local users of the computing system 902 as well as to remote users accessing the computing system 902 from one or more client machines 906 over a network connection 910. One or more user interface screens produced by the one or more first modules can be displayed to a user, either via a local display or via a display associated with one of the client machines 906. Data units of the data storage application 904 can be transiently stored in a persistence layer 912 (e.g., a page buffer or other type of temporary persistency layer), which can write the data, in the form of storage pages, to one or more storages 914, for example via an input/output component 916. The one or more storages 914 can include one or more physical storage media or devices (e.g. hard disk drives, persistent flash memory, random access memory, optical media, magnetic media, and the like) configured for writing data for longer term storage. It should be noted that the storage 914 and the input/output component 916 can be included in the computing system 902 despite their being shown as external to the computing system 902 in FIG. 9.

Data retained at the longer term storage 914 can be organized in pages, each of which has allocated to it a defined amount of storage space. In some implementations, the amount of storage space allocated to each page can be constant and fixed. However, other implementations in which the amount of storage space allocated to each page can vary are also within the scope of the current subject matter.

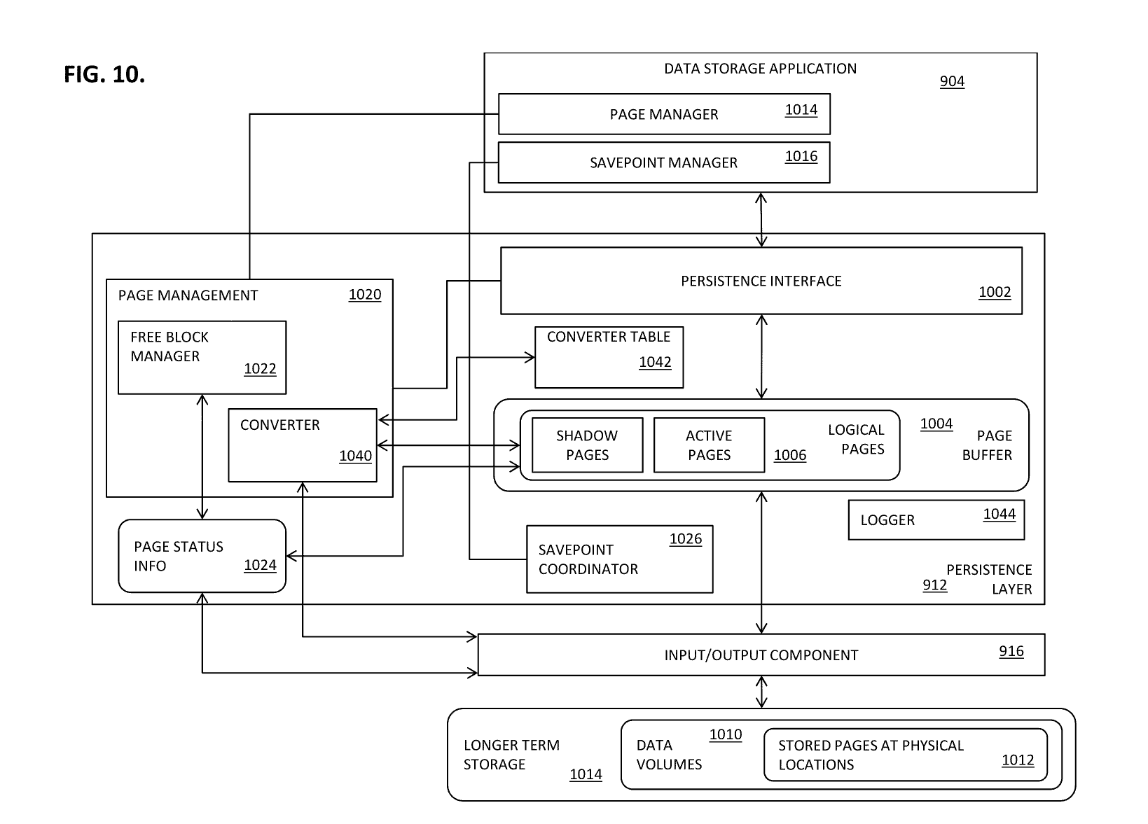

FIG. 10 illustrates an exemplary software architecture 1000, according to some implementations of the current subject matter. A data storage application 904, which can be implemented in one or more of hardware and software, can include one or more of a database application, a network-attached storage system, or the like. According to at least some implementations of the current subject matter, such a data storage application 904 can include or otherwise interface with a persistence layer 912 or other type of memory buffer, for example via a persistence interface 1002. A page buffer 1004 within the persistence layer 912 can store one or more logical pages 1006, and optionally can include shadow pages, active pages, and the like. The logical pages 1006 retained in the persistence layer 912 can be written to a storage (e.g. a longer term storage, etc.) 914 via an input/output component 916, which can be a software module, a sub-system implemented in one or more of software and hardware, or the like. The storage 914 can include one or more data volumes 1010 where stored pages 1012 are allocated at physical memory blocks.

In some implementations, the data storage application 904 can include or be otherwise in communication with a page manager 1014 and/or a savepoint manager 1016. The page manager 1014 can communicate with a page management module 1020 at the persistence layer 912 that can include a free block manager 1022 that monitors page status information 1024, for example the status of physical pages within the storage 914 and logical pages in the persistence layer 912 (and optionally in the page buffer 1004). The savepoint manager 1016 can communicate with a savepoint coordinator 1026 at the persistence layer 912 to handle savepoints, which are used to create a consistent persistent state of the database for restart after a possible crash.

In some implementations of a data storage application 904, the page management module of the persistence layer 912 can implement a shadow paging. The free block manager 1022 within the page management module 1020 can maintain the status of physical pages. The page buffer 1004 can included a fixed page status buffer that operates as discussed herein. A converter component 1040, which can be part of or in communication with the page management module 1020, can be responsible for mapping between logical and physical pages written to the storage 914. The converter 1040 can maintain the current mapping of logical pages to the corresponding physical pages in a converter table 1042. The converter 1040 can maintain a current mapping of logical pages 1006 to the corresponding physical pages in one or more converter tables 1042. When a logical page 1006 is read from storage 914, the storage page to be loaded can be looked up from the one or more converter tables 1042 using the converter 1040. When a logical page is written to storage 914 the first time after a savepoint, a new free physical page is assigned to the logical page. The free block manager 1022 marks the new physical page as “used” and the new mapping is stored in the one or more converter tables 1042.

The persistence layer 912 can ensure that changes made in the data storage application 904 are durable and that the data storage application 904 can be restored to a most recent committed state after a restart. Writing data to the storage 914 need not be synchronized with the end of the writing transaction. As such, uncommitted changes can be written to disk and committed changes may not yet be written to disk when a writing transaction is finished. After a system crash, changes made by transactions that were not finished can be rolled back. Changes occurring by already committed transactions should not be lost in this process. A logger component 1044 can also be included to store the changes made to the data of the data storage application in a linear log. The logger component 1044 can be used during recovery to replay operations since a last savepoint to ensure that all operations are applied to the data and that transactions with a logged “commit” record are committed before rolling back still-open transactions at the end of a recovery process.

With some data storage applications, writing data to a disk is not necessarily synchronized with the end of the writing transaction. Situations can occur in which uncommitted changes are written to disk and while, at the same time, committed changes are not yet written to disk when the writing transaction is finished. After a system crash, changes made by transactions that were not finished must be rolled back and changes by committed transaction must not be lost.

To ensure that committed changes are not lost, redo log information can be written by the logger component 1044 whenever a change is made. This information can be written to disk at latest when the transaction ends. The log entries can be persisted in separate log volumes while normal data is written to data volumes. With a redo log, committed changes can be restored even if the corresponding data pages were not written to disk. For undoing uncommitted changes, the persistence layer 912 can use a combination of undo log entries (from one or more logs) and shadow paging.

The persistence interface 1002 can handle read and write requests of stores (e.g., in-memory stores, etc.). The persistence interface 1002 can also provide write methods for writing data both with logging and without logging. If the logged write operations are used, the persistence interface 1002 invokes the logger 1044. In addition, the logger 1044 provides an interface that allows stores (e.g., in-memory stores, etc.) to directly add log entries into a log queue. The logger interface also provides methods to request that log entries in the in-memory log queue are flushed to disk.

Log entries contain a log sequence number, the type of the log entry and the identifier of the transaction. Depending on the operation type additional information is logged by the logger 1044. For an entry of type “update”, for example, this would be the identification of the affected record and the after image of the modified data.

When the data application 904 is restarted, the log entries need to be processed. To speed up this process the redo log is not always processed from the beginning. Instead, as stated above, savepoints can be periodically performed that write all changes to disk that were made (e.g., in memory, etc.) since the last savepoint. When starting up the system, only the logs created after the last savepoint need to be processed. After the next backup operation the old log entries before the savepoint position can be removed.

When the logger 1044 is invoked for writing log entries, it does not immediately write to disk. Instead it can put the log entries into a log queue in memory. The entries in the log queue can be written to disk at the latest when the corresponding transaction is finished (committed or aborted). To guarantee that the committed changes are not lost, the commit operation is not successfully finished before the corresponding log entries are flushed to disk. Writing log queue entries to disk can also be triggered by other events, for example when log queue pages are full or when a savepoint is performed.

With the current subject matter, the logger 1044 can write a database log (or simply referred to herein as a “log”) sequentially into a memory buffer in natural order (e.g., sequential order, etc.). If several physical hard disks/storage devices are used to store log data, several log partitions can be defined. Thereafter, the logger 1044 (which as stated above acts to generate and organize log data) can load-balance writing to log buffers over all available log partitions. In some cases, the load-balancing is according to a round-robin distributions scheme in which various writing operations are directed to log buffers in a sequential and continuous manner. With this arrangement, log buffers written to a single log segment of a particular partition of a multi-partition log are not consecutive. However, the log buffers can be reordered from log segments of all partitions during recovery to the proper order.

As stated above, the data storage application 904 can use shadow paging so that the savepoint manager 1016 can write a transactionally-consistent savepoint. With such an arrangement, a data backup comprises a copy of all data pages contained in a particular savepoint, which was done as the first step of the data backup process. The current subject matter can be also applied to other types of data page storage.

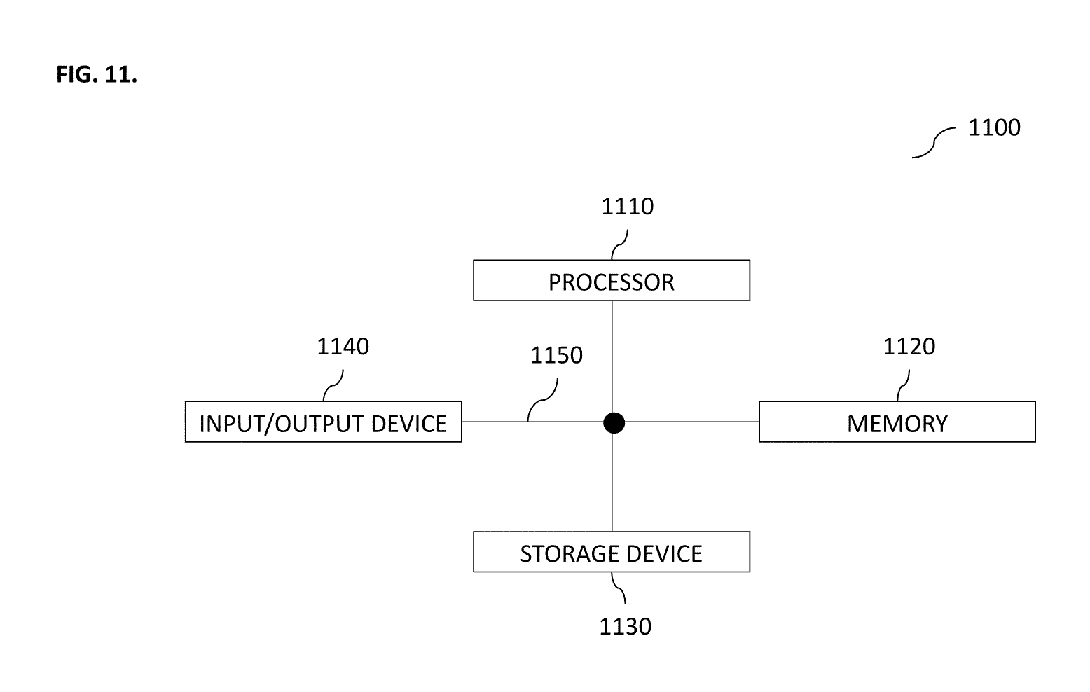

In some implementations, the current subject matter can be configured to be implemented in a system 1100, as shown in FIG. 11. The system 1100 can include a processor 1110, a memory 1120, a storage device 1130, and an input/output device 1140. Each of the components 1110, 1120, 1130 and 1140 can be interconnected using a system bus 1150. The processor 1110 can be configured to process instructions for execution within the system 1100. In some implementations, the processor 1110 can be a single-threaded processor. In alternate implementations, the processor 1110 can be a multi-threaded processor. The processor 1110 can be further configured to process instructions stored in the memory 1120 or on the storage device 1130, including receiving or sending information through the input/output device 1140. The memory 1120 can store information within the system 1100. In some implementations, the memory 1120 can be a computer-readable medium. In alternate implementations, the memory 1120 can be a volatile memory unit. In yet some implementations, the memory 1120 can be a non-volatile memory unit. The storage device 1130 can be capable of providing mass storage for the system 1100. In some implementations, the storage device 1130 can be a computer-readable medium. In alternate implementations, the storage device 1130 can be a floppy disk device, a hard disk device, an optical disk device, a tape device, non-volatile solid state memory, or any other type of storage device. The input/output device 1140 can be configured to provide input/output operations for the system 1100. In some implementations, the input/output device 1140 can include a keyboard and/or pointing device. In alternate implementations, the input/output device 1140 can include a display unit for displaying graphical user interfaces.

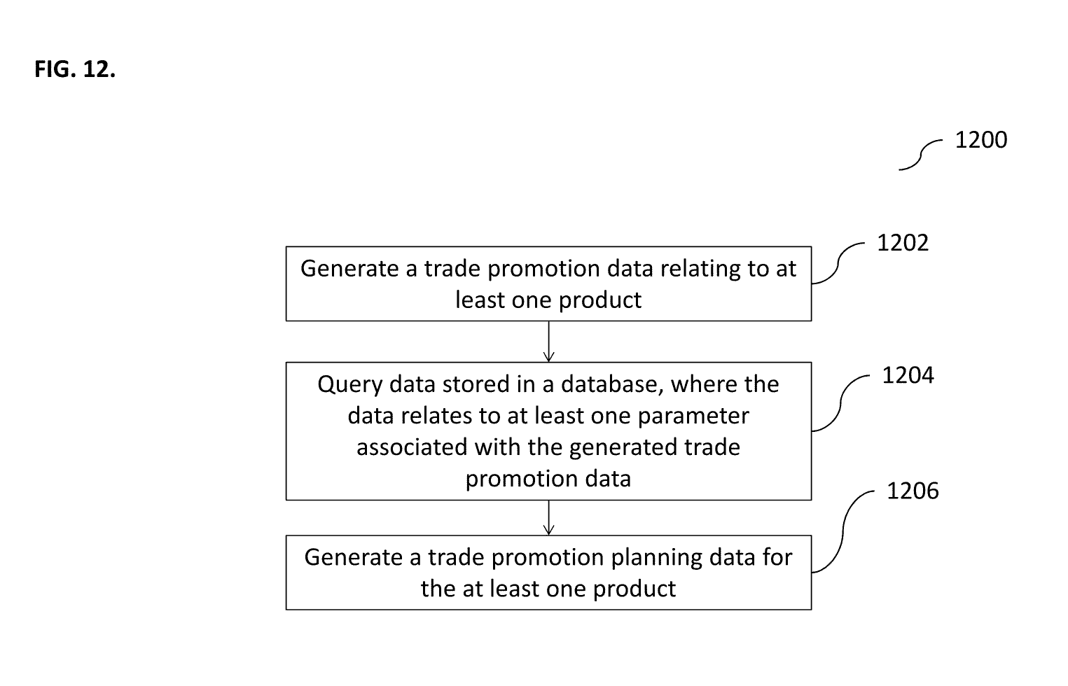

FIG. 12 illustrates an exemplary method 1200 for promotion planning, according to some implementations of the current subject matter. At 1202, a promotion data relating to at least one product can be generated (e.g., product information, promotion information, customer information, etc.). At 1204, data stored in a database (e.g., business warehouse) can be queried based on the generated promotion data. The queried data can relate to at least one parameter associated with the generated promotion data (e.g., promotion type, sale type, price, discount, volume, etc.). At 1206, a promotion planning data for the at least one product can be generated based on the querying.

In some implementations, the current subject matter can include one or more of the following optional features. The method can further include arranging the generated promotion planning data in a single user interface and displaying the arranged generated promotion planning data in the single user interface.

In some implementations, the single user interface can include a spreadsheet containing a plurality of data cells. The promotion planning data can include promotion planning data for a plurality of products. The promotion planning data can be grouped into at least one group based on at least one promotion planning parameter.

In some implementations, the database can be located in a business warehouse that can store at least one key figure parameter associated with at least on promotion planning data. The single user interface can communicate with the business warehouse using a planning connector for performing at least one of the query, generation of the promotion planning data, arrangement and displaying of the data on the user interface.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method, comprising:
generating a trade promotion data relating to at least one product;
querying, based on the generated trade promotion data, data stored in a database, wherein the data relates to at least one parameter associated with the generated trade promotion data; and
generating, based on the querying, a trade promotion planning data for the at least one product;
wherein the at least one of the generating the trade promotion data, the querying, and the generating the trade promotion planning data is performed on at least one processor of at least one computing system.

2. The method according to claim 1, further comprising
arranging the generated trade promotion planning data in a single user interface; and
displaying the arranged generated trade promotion planning data in the single user interface.

3. The method according to claim 2, wherein the single user interface includes a spreadsheet containing a plurality of data cells.

4. The method according to claim 1, wherein the trade promotion planning data includes trade promotion planning data for a plurality of products.

5. The method according to claim 4, wherein the trade promotion planning data is grouped into at least one group based on at least one trade promotion planning parameter.

6. The method according to claim 4, wherein the trade promotion planning data is generated for the plurality of products simultaneously.

7. The method according to claim 2, wherein the at least one database is located in a business warehouse storing at least one key figure parameter associated with at least on promotion planning data.

8. The method according to claim 7, wherein the single user interface communicates with the business warehouse using a planning connector for performing at least one of the querying, the generating the promotion planning data, the arranging, and the displaying.

9. A system comprising:
at least one programmable processor; and
a machine-readable medium storing instructions that, when executed by the at least one programmable processor, cause the at least one programmable processor to perform operations comprising:
generating a trade promotion data relating to at least one product;
querying, based on the generated trade promotion data, data stored in a database, wherein the data relates to at least one parameter associated with the generated trade promotion data; and
generating, based on the querying, a trade promotion planning data for the at least one product.

10. The system according to claim 9, wherein the operations further comprise
arranging the generated trade promotion planning data in a single user interface; and
displaying the arranged generated trade promotion planning data in the single user interface.

11. The system according to claim 10, wherein the single user interface includes a spreadsheet containing a plurality of data cells.

12. The system according to claim 9, wherein the trade promotion planning data includes trade promotion planning data for a plurality of products.

13. The system according to claim 12, wherein the trade promotion planning data is grouped into at least one group based on at least one trade promotion planning parameter.

14. The system according to claim 12, wherein the trade promotion planning data is generated for the plurality of products simultaneously.

15. The system according to claim 10, wherein the at least one database is located in a business warehouse storing at least one key figure parameter associated with at least on promotion planning data.

16. The system according to claim 15, wherein the single user interface communicates with the business warehouse using a planning connector for performing at least one of the querying, the generating the promotion planning data, the arranging, and the displaying.

17. A computer program product comprising a machine-readable medium storing instructions that, when executed by at least one programmable processor, cause the at least one programmable processor to perform operations comprising:
generating a trade promotion data relating to at least one product;
querying, based on the generated trade promotion data, data stored in a database, wherein the data relates to at least one parameter associated with the generated trade promotion data; and
generating, based on the querying, a trade promotion planning data for the at least one product.

18. The computer program product according to claim 17, wherein the operations further comprise
arranging the generated trade promotion planning data in a single user interface; and
displaying the arranged generated trade promotion planning data in the single user interface.

19. The computer program product according to claim 18, wherein the single user interface includes a spreadsheet containing a plurality of data cells.

20. The computer program product according to claim 17, wherein the trade promotion planning data
includes trade promotion planning data for a plurality of products;
is grouped into at least one group based on at least one trade promotion planning parameter; and
is generated for the plurality of products simultaneously.
